(19) United States
(12) Patent Application Publication
(10) Pub. No.: US 2008/0116425 A1
(43) Pub. Date: May 22, 2008

(54) Transparent conductive film and method of manufacturing the same

(75) Inventor: Noriyuki Yasuda, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/979,825

(22) Filed: Nov. 8, 2007

(30) Foreign Application Priority Data
Nov. 17, 2006 (JP) 2006-312022

(51) Int. Cl. H01B 1/22

(52) U.S. Cl. 252/518.1

(57) ABSTRACT

A transparent conductive film containing conductive particles constituted by first conductive particles having a particle size of at least 20 nm and second conductive particles having a particle size of less than 20 nm, and a binder resin; wherein R²/R¹ is 0.05 to 0.5, where R¹ is an average particle size of the first conductive particles, and R² is an average particle size of the second conductive particles.

### BACKGROUND OF THE INVENTION

1. Field of the Invention

The present invention relates to a transparent conductive film and a method of manufacturing the same.

2. Related Background Art

Transparent conductive films have been in use as transparent electrodes in panel switches such as touch panels, for example. In general, a panel switch is constructed by a pair of transparent electrodes opposing each other and a spacer held between the pair of transparent electrodes, in which energization occurs in a part where one transparent electrode is pushed into contact with the other transparent electrode. According to this energization, the position of the pushed part is detected. Known as an example of the transparent conductive films is a coating type transparent conductive film formed by using an electron-beam-curable ink containing fine particles of indium tin oxide (see, for example, Japanese Patent No. 3072862).

### SUMMARY OF THE INVENTION

For use in touch panels and the like, however, transparent conductive films having a high reliability with suppressed changes in resistance due to moisture have been in demand.

It is therefore an object of the present invention to provide a transparent conductive film having a high reliability with a sufficiently suppressed change in resistance.

In one aspect, the present invention provides a transparent conductive film comprising a transparent conductive layer containing conductive particles constituted by first conductive particles having a particle size of at least 20 nm and second conductive particles having a particle size of less than 20 nm, and a binder resin; wherein R²/R¹ is 0.05 to 0.5, where R¹ is an average particle size of the first conductive particles, and R² is an average particle size of the second conductive particles.

The transparent conductive film in accordance with this aspect of the present invention attains a high reliability with a sufficiently suppressed change in resistance by using the first conductive particles having a particle size of at least 20 nm and the second conductive particles having a specific average particle size finer than that of the first conductive particles. It seems that, when the binder is swollen with moisture, a part where a conductive path breaks occurs, thereby changing the resistance. When the finer second conductive particles are used, by contrast, it seems that the transparent conductive film is filled with a higher density of the conductive particles, so that the binder resin is harder to swell upon moisture absorption, whereby the resistance change is suppressed.

Preferably, the second conductive particles has a hydrophobized or hydrophilized surface. When hydrophobized, the dispersibility of the second conductive particles into the binder resin becomes better, thereby making the effect of suppressing the resistance change more remarkable. When hydrophilized, on the other hand, the second conductive particles are easier to attach to the first conductive particle surface, thus forming a conductive path more efficiently, thereby yielding a lower resistance value.

Preferably, a substituent having a functional group which reacts with the binder resin is bonded to the surface of the second conductive particles. As a consequence, the effects of making the resistance lower and reliability higher are exhibited more remarkably.

The second conductive particles may be unevenly distributed toward one surface side of the transparent conductive film in the thickness direction thereof. In this case, the conductive path is formed efficiently in particular on the surface on the side where the second conductive particles are distributed more. This can yield the effect of attaining a sufficiently low resistance while keeping a low concentration of the second conductive particles as a whole.

The transparent conductive layer may have a conductive layer where the first and second conductive particles coexist as the conductive particles; and a layer, formed on one side or both sides of the conductive layer, having only the second conductive particles distributed therein as the conductive particles.

In another aspect, the present invention provides a method of manufacturing a transparent conductive film, the method comprising the steps of forming a sheet-shaped aggregate including conductive particles having an average particle size of at least 20 nm flocculated therein; and impregnating the aggregate with a conductive particle having an average particle size of less than 20 nm together with a binder resin.

In the manufacturing method in accordance with the present invention, a gap between conductive, particles having an average particle size of at least 20 nm is easily filled with fine conductive particles having an average particle size of less than 20 nm. This yields a transparent conductive film having a high reliability with a suppressed change in resistance.

### BRIEF DESCRIPTION OF THE DRAWINGS

FIG. 1 is a sectional view showing one embodiment of the transparent conductive film;

FIG. 2 is a sectional view showing another embodiment of the transparent conductive film;

FIG. 3 is a view for explaining the definition of particle size of a conductive particle; and

FIG. 4 is a sectional view showing a state where an aggregate containing a plurality of flocculated conductive particles is formed on a base.

### DESCRIPTION OF THE PREFERRED EMBODIMENTS

In the following, preferred embodiments of the present invention will be explained in detail. However, the present invention is not limited to the following embodiments.

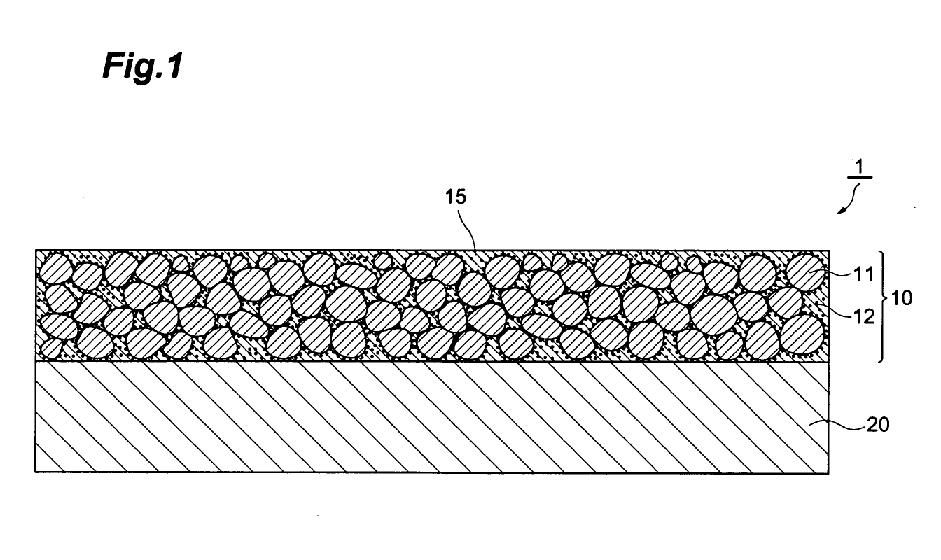

FIG. 1 is a sectional view showing one embodiment of the transparent conductive film. The transparent conductive film 1 comprises a base 20 and a transparent conductive layer 10 formed on the base 20. In the transparent conductive layer 10, a plurality of first conductive particles 11 and a plurality of second conductive particles 12 are dispersed in a binder resin 15. The first conductive particles 11 are in contact with each other so as to form conductive paths in the transparent conductive layer 10. At least a part of the second conductive particles 12 attach to the surfaces of the first conductive particles 11, so that the conductive paths are formed through the attached second conductive particles 12, whereby a sufficiently low electric resistance value is obtained. Since the second conductive particles 12 are dispersed in the binder resin 15 between the first conductive particles 11, the filler effect makes the binder resin 15 harder to swell, whereby the resistance change at the time of moisture absorption can be suppressed.

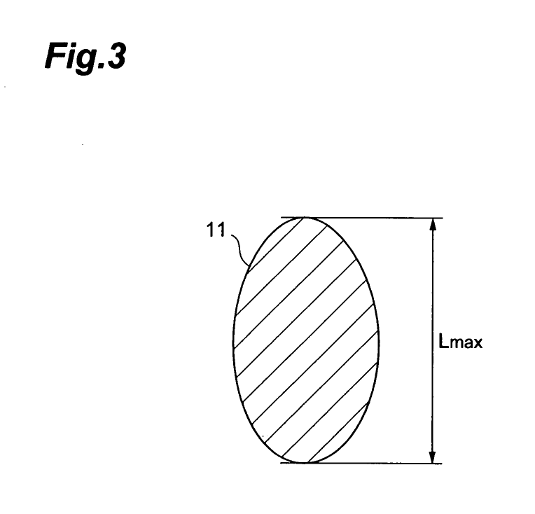

The first conductive particles 11 have a particle size of at least 20 nm, while the second conductive particles 12 have a particle size of less than 20 nm. The particle size in this case refers to the maximum particle size in a cross section of a particle (the maximum value of the distance between two parallel lines holding the particle therebetween) Lmax (see FIG. 3). The cross section of a conductive particle is observed by using transmission electron micrography (TEM method), for example.

When R¹ is the average particle size of the first conductive particles 11, and R² is the average particle size of the second conductive particles 12, R²/R¹ falls within the range of 0.05 to 0.5. R¹ and R² are determined by a method of measuring the respective particle sizes of the first and second conductive particles observed in a given cross section and averaging them. For the sake of accuracy, it will be preferred if the particle sizes of 50 or more first or second conductive particles are measured at the time of determining the average particle size.

For making the effects of attaining a lower resistance, a higher reliability, and the like more remarkable, R²/R¹ is preferably 0.4 or less, more preferably 0.3 or less. On the other hand, R²/R¹ is preferably at least 0.1, more preferably at least 0.15.

Preferably, R¹ is 20 to 80 nm. When R¹ exceeds 80 nm, the transparent conductive layer 10 is harder to attain a sufficient light transmissibility, while its haze value tends to increase. Preferably, R² is 1 to 10 nm.

Preferably, the ratio of the first conductive particles 11 to the transparent conductive layer 10 is 30 to 80% by volume. The resistance value of the transparent conductive film 1 tends to increase when the ratio is less than 30% by volume, whereas the mechanical strength of the transparent conductive film 1 tends to decrease when the ratio exceeds 80% by volume.

Preferably, the ratio of the second conductive particles 12 to the transparent conductive layer 10 is 5 to 15% by volume. This remarkably yields the effects of attaining a lower resistance and a higher reliability in particular. When the ratio of the second conductive particles 12 is less than 5% by volume, conductive paths are not formed sufficiently, whereby the effect of attaining a lower resistance tends to decrease. When the ratio exceeds 15% by volume, the light transmissibility and mechanical strength tend to decrease.

Preferably, the ratio of the second conductive particles 12 to the total amount of the first conductive particles 11 and second conductive particles 12 is 5 to 40% by volume. The effects of attaining a lower resistance and a higher reliability tend to decrease when the ratio is outside of the range mentioned above. From a similar point of view, the ratio is more preferably 10 to 30%.

When the transparent conductive layer 10 has a structure including a conductive layer 51 which will be explained later and an intermediate layer 52 in which only the second conductive particles 12 are distributed, the ratios of the above-mentioned conductive particles to the transparent conductive layer 10 are read as the ratios of the conductive particles to the conductive layer 51. Similarly, the ratio of the second conductive particles 12 to the total amount of the first conductive particles 11 and second conductive particles 12 in the transparent conductive layer 10 in the above-mentioned embodiment is read as the ratio of the second conductive particles 12 to the total amount of the first conductive particles 11 and second conductive particles 12 in the conductive layer 51.

The second conductive particles 12 are distributed substantially uniformly in the thickness direction of the transparent conductive layer 10 in this embodiment, but may be unevenly distributed toward one surface side of the transparent conductive layer 10. In other words, when a cross section of the transparent conductive layer 10 is equally divided into two in the thickness direction thereof, the second conductive particles 12 may be distributed such as to have a greater concentration in one area than in the other area.

The first conductive particles 11 are constituted by a transparent conductive oxide. Specific examples of the transparent conductive oxide include indium oxide; indium oxide doped with at least one kind of element selected from the group consisting of tin, zinc, tellurium, silver, gallium, zirconium, hafnium, and magnesium; tin oxide; tin oxide doped with at least one kind of element selected from the group consisting of antimony, zinc, and fluorine; zinc oxide; and zinc oxide doped with at least one kind of element selected from the group consisting of aluminum, gallium, indium, boron, fluorine, and manganese. Among them, particles of indium-tin composite oxide (ITO) in which indium oxide is doped with tin are most typically used as the first conductive particles 11. The method of making these transparent conductive oxides is not limited in particular, whereby those made by dry methods, wet methods, spray decomposition methods, laser ablation methods, plasma methods, and the like can be utilized as appropriate.

The same transparent conductive oxide as that of the first conductive particles 11 can be used as a conductive material constituting the second conductive particles 12. The second conductive particles 12 have a particle size of less than 20 nm, and thus are not required to be transparent by themselves, whereby metal particles may be used as the second conductive particles 12, for example. The same method as that for the above-mentioned first conductive particles 11 can be used for the method of making the second conductive particles 12. The first conductive particles 11 and second conductive particles 12 are not restricted in particular, whereby two or more species of each may be mixed as well.

Preferably, the surface of the second conductive particles 12 is hydrophobized or hydrophilized. Specifically, hydrophobization is carried out by a method of attaching or combining a compound having a hydrophobic group to the surface of the second conductive particles 12. Specifically, hydrophilization is carried out by a method of attaching or combining a compound having a hydrophilic group to the surface of the second conductive particles 12.

Examples of the hydrophobic group include chain or cyclic hydrocarbon groups and fluorinated carbon groups. More specific examples include alkyl, alkenyl, alkynyl, aryl, cycloalkyl, fluorinated alkyl, fluorinated aryl, and fluorinated cycloalkyl groups. They may have substituents.

Specific examples of the compound having a hydrophobic group include vinyltrichlorosilane, vinyltrimethoxysilane, vinyltriethoxysilane, cyclohexylaminopropyltrimethoxysilane, divinyltetramethyldisilazane, phenyltristrimethylsiloxysilane, trifluoropropyltrimethoxysilane, β-(3,4-epoxycyclohexyl)ethyltrimethoxysilane, γ-glycidoxypropyltrimethoxysilane, γ-methacryloxypropyltrimethoxysilane, N-phenyl-γ-aminopropyltrimethoxysilane, sodium stearate, sodium 2-ethylhexylsulfate, sodium alkylbenzenesulfonate, oleyl sarcosinate, octadecylamine acetate, polyethylene glycol lauryl ether, polyethylene glycol octylphenyl ether, sorbitan trioleate, lauric diethanolamide, polyethylene glycol stearylamine, acetoalkoxyaluminum diisopropylate, isopropyltriisostearoyl titanate, isopropyltris(dioctylpyrophosphate) titanate, isopropyl(N-aminoethyl-aminoethyl)titanate, tetra(2,2-diallyloxymethyl-1-butyl)bis(ditridecyl)phosphate titanate, bis(dioctylpyrophosphate)oxyacetate titanate, bis(dioctylpyrophosphate)ethylene titanate, and isopropyldimethacrylisostearoyl titanate. The above-mentioned compounds are illustrative but not restrictive.

Examples of the hydrophilic group include hydroxyl, carboxyl, carbonyl, oxy, amino, amido, cyano, urethane, phosphoryl, and thio groups.

Specific examples of the compound having a hydrophilic group include γ-aminopropyltrimethoxysilane, γ-mercaptopropyltrimethoxysilane, 1,3-bis(3-mercaptopropyl)tetramethyldisilazane, 1,3-bis(3-aminopropyl)tetramethyldisilazane, γ-glycidoxypropyltrimethoxysilane, γ-ureidopropyltriethoxysilane, and γ-isocyanatopropyltriethoxysilane.

Preferably, a substituent having a functional group which reacts with the binder resin is bonded to the surface of the second conductive particles 12. The substituent having a functional group which reacts with the binder resin is introduced typically as the above-mentioned hydrophobic or hydrophilic group. Specific examples of the functional group which reacts with the binder resin include vinyl, amino, epoxy, acryl, and methacryl groups. When the binder resin is an acrylic resin, unsaturated groups such as vinyl, acryl, and methacryl groups are preferred, for example.

Employable as a method of hydrophobizing or hydrophilizing the surface of the second conductive particles 12 is one attaching a processing liquid containing a compound having a hydrophobic group or a compound having a hydrophilic group to a conductive particles and then drying the liquid, for example. Instead of preprocessing the second conductive particles 12, a compound having a hydrophobic group or a compound having a hydrophilic group may be added to a mixed liquid which will be explained later and is used when making a transparent conductive film, so that the hydrophobization or hydrophilization is carried out simultaneously with impregnating with the second conductive particles 12 having an average particle size of less than 20 nm together with the binder resin.

The binder resin 15 is not restricted in particular as long as it is a transparent resin which can secure the first conductive particles 11 and second conductive particles 12. Specific examples of the binder resin 15 include acrylic resins, epoxy resins, polystyrene, polyurethane, silicone resins, and fluoride resins.

Among them, the binder resin 15 is preferably an acrylic resin. Using the acrylic resin can further improve the light transmissibility of the transparent conductive film 1. The acrylic resin is excellent not only in resistances to acids and alkalis, but also in the resistance to scratches (surface hardness).

The acrylic resin is a resin mainly composed of a polymer formed by polymerizing a monomer having a (meth)acryl group. Typically, the acrylic resin is formed by hardening a resin composition containing a (meth)acrylic monomer such as (meth)acrylate ester, an acrylic polymer such as polymethyl methacrylate, and a polymerization initiator. As the (meth)acrylic monomer, one having one or more (meth)acryl groups is used. The (meth)acrylic monomer may also be used as a mixture of several species.

The transparent conductive layer 10 may contain other components in addition to those in the foregoing. Examples of the other components include conductive compounds, organic or inorganic fillers, surface treatment agents, crosslinkers, UV absorbents, radical scavengers, colorants, and plasticizers.

Preferably, the thickness of the transparent conductive layer 10 is 0.1 to 5 μm. The resistance value is harder to stabilize when the thickness is less than 0.1 μm, whereas a sufficient light transmissibility is harder to attain when the thickness exceeds 5 μm.

Though the base 20 is not restricted in particular as long as it can support the transparent conductive layer 10, a transparent film is preferably used therefor. Specifically, a film of polyester such as polyethylene terephthalate (PET), polyolefin such as polyethylene and polypropylene, polycarbonate, acrylic resin, polynorbornene-based resin, or polysiloxane-based resin is used as the base 20. Alternatively, a glass substrate may be used as the base 20.

Other layers may be provided between the base 20 and transparent conductive layer 10. Examples of the other layers include functional layers such as buffer, auxiliary conductive, dispersion prevention, UV-blocking, coloring, and polarizing layers.

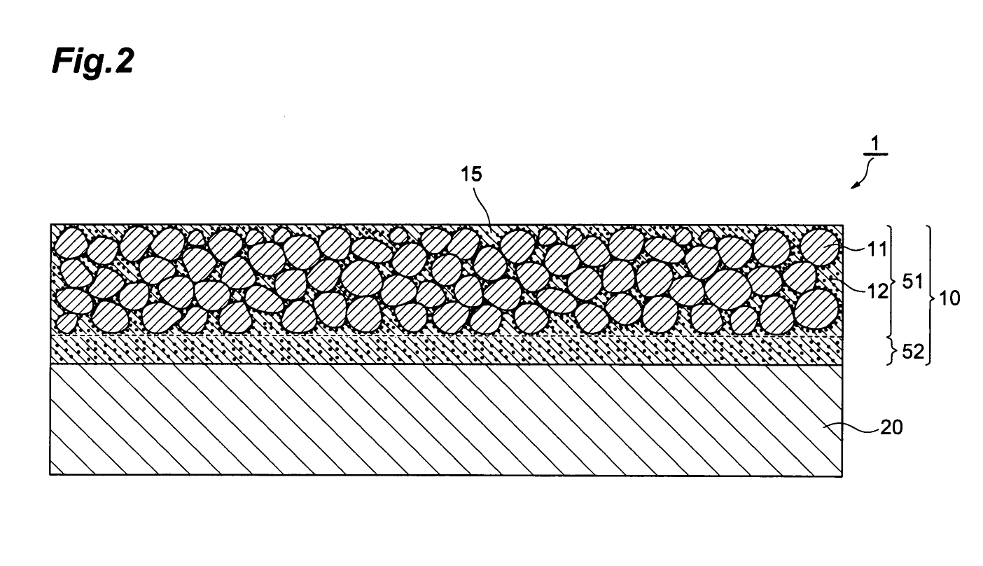

As in the embodiment shown in FIG. 2, the transparent conductive film in accordance with the present invention may be constituted by the conductive layer 51 in which the first conductive particles 11 and second conductive particles 12 coexist as the conductive particles, and the intermediate layer 52 in which only the second conductive particles 12 are distributed as the conductive particles. The intermediate layer 52 is formed as the outermost layer on one surface side of the transparent conductive layer 10. Though the intermediate layer 52 does not substantially contain the first conductive particles 11, i.e., the conductive particles having a particle size of 20 nm or greater, this embodiment also encompasses the case where a minute amount of the first conductive particles 11 mingle in the intermediate layer 52. In the latter case, the ratio of the first conductive particles contained in the intermediate layer 52 is 15% by volume or less, for example. Since such an intermediate layer 52 is formed, filler and anchor effects can restrain the intermediate layer 52 from swelling, and an effect of further lowering fluctuations in resistance is obtained.

The transparent conductive film 1 can be obtained, for example, by a manufacturing method comprising the steps of forming a sheet-shaped aggregate including conductive particles having an average particle size of at least 20 nm flocculated therein and impregnating the aggregate with conductive particles having an average particle size of less than 20 nm together with a binder resin.

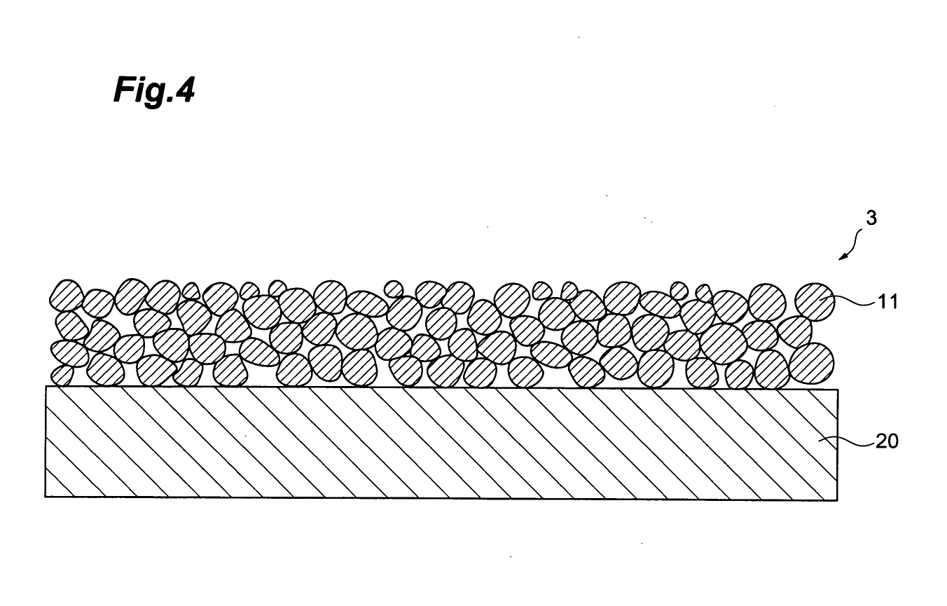

FIG. 4 is a sectional view showing a state where an aggregate containing a plurality of flocculated conductive particles is formed on a base. The aggregate 3 shown in FIG. 4 is substantially constituted by the first conductive particles 11 having a particle size of at least 20 nm. Here, it will be sufficient if the conductive particles constituting the aggregate have an average particle size of at least 20 nm as a whole, whereas conductive particles having a particle size of less than 20 nm may coexist therewith. Specifically, it will be preferred if at least 80% by volume of the conductive particles constituting the aggregate have a particle size of at least 20 nm. The average particle size of the conductive particles constituting the aggregate is preferably 20 to 80 nm, more preferably 20 to 50 nm.

The aggregate 3 is formed, for example, by a method including the steps of applying a dispersion liquid containing conductive particles having an average particle size of at least 20 nm and a solvent onto the base 20, removing the solvent from the applied dispersion liquid, and pressing the conductive particles remaining on the base 20, so as to form a sheet-shaped aggregate in which the conductive particles are flocculated. The solvent in the dispersion liquid is not restricted in particular, whereby an alcohol such as ethanol is preferably used. The conductive particles are pressed, for example, by a method of laminating a film such as PET film on the conductive particles, and causing pressure rolls to hold therebetween a multilayer body in which the base, conductive particles, and film are successively laminated. The pressing secures the conductive particles in a state where they are flocculated together.

Subsequently, the gaps between the conductive particles in the aggregate 3 formed on the base 20 are filled with the conductive particles having an average particle size of less than 20 nm and a binder resin, so as to yield the transparent conductive film 1 shown in FIG. 1. When the binder resin 15 is an acrylic resin, the aggregate 3 is impregnated with the conductive particles having an average particle size of less than 20 nm together with the binder resin, for example, by a method including the steps of impregnating the aggregate 3 with a mixed liquid containing an uncured binder resin (acrylic resin), conductive particles having an average particle size of less than 20 nm, and a solvent; removing the solvent from the mixed liquid; and curing the binder resin (acrylic resin). The impregnating step is not required to be carried out at once, but may be done in a plurality of operations. When carrying out a plurality of impregnating operations, mixed liquids with different concentrations of conductive particles may also be used.

The average particle size of the conductive particles with which the aggregate 3 is impregnated is preferably 1 to 20 nm, more preferably 1 to 10 nm. In this embodiment, the conductive particles with which the aggregate 3 is impregnated are substantially constituted by conductive particles having a particle size of less than 20 nm. Here, it will be sufficient if the conductive particles with which the aggregate is impregnated have an average particle size of less than 20 nm as a whole, while conductive particles having a particle size of at least 20 nm may coexist therewith. Specifically, it will be preferred if at least 70% by volume of the conductive particles with which the aggregate is impregnated have a particle size of less than 20 nm.

Examples of the solvent used in the mixed liquid include saturated hydrocarbons such as hexane; aromatic hydrocarbons such as toluene and xylene; alcohols such as methanol, ethanol, propanol, and butanol; ketones such as acetone, methylethylketone, isobutylmethylketone, and diisobutylketone; esters such as ethyl acetate and butyl acetate; ethers such as tetrahydrofuran, dioxane, and diethyl ether; and amides such as N,N-dimethylacetamide, N,N-dimethylformamide, and N-methylpyrrolidone. The method of preparing the mixed liquid is not limited in particular. For example, the conductive particles and binder resin may be mixed before being added to the solvent, or the binder may be dissolved in the solvent before adding the conductive particles thereto.

The mixed liquid is applied onto the aggregate 3 and infiltrated therein, whereby the aggregate 3 is impregnated with the mixed liquid. Examples of the method of applying the mixed liquid include reverse rolling, direct rolling, blading, knifing, extrusion, nozzle method, curtaining, gravure rolling, bar coating, dipping, kiss coating, spin coating, squeezing, and spraying.

The mixed liquid with which the aggregate 3 is impregnated is heated, so as to remove the solvent. Thereafter, the (meth)acrylic monomer in the acrylic resin is polymerized, so as to cure the acrylic resin. The curing of the acrylic resin can be progressed by irradiation with active rays or heating. Curing the acrylic resin forms the binder resin 15 made of a cured product of the acrylic resin, thereby yielding the transparent conductive film 1.

Conductive particles having a predetermined average particle size can be manufactured by a known method as is understandable by one skilled in the art. For example, those of ITO particles can be obtained by a method spraying an aqueous solution having dissolved indium chloride and stannic chloride therein into an atmosphere heated to 500° C. or higher. ITO particles having a desirable average particle size can be obtained by regulating the size of droplets of the aqueous solution to be sprayed, additives, the concentration of the aqueous solution, heating temperature, and components and concentrations of atmospheres.

Though the transparent conductive film 1 is mainly used in the state having the base 20, the transparent conductive film can also be used by itself as a transparent conductive film while separating the base 20 therefrom. The transparent conductive film 1 is favorably used as a transparent electrode for panel switches such as touch panels and light-transmitting switches. For example, the transparent conductive layer 10 is used as at least one of transparent electrodes in a touch panel comprising a pair of transparent electrodes opposing each other and a dot spacer held between the transparent electrodes. The transparent conductive layer 10 can be used in not only the panel switches but also antinoise components, heating elements, electrodes for EL, electrodes for backlight, LCD, PDP, antennas, illuminants, and the like.

### EXAMPLES

The present invention will now be explained in more detail with reference to examples. However, the present invention is not restricted to the following examples.

Making of Conductive Particles

ITO particles were made by a method of spraying an aqueous solution having dissolved indium chloride and stannic chloride therein into an atmosphere heated to 500° C. or higher. Several kinds of ITO particles were made by changing the size of droplets of the aqueous solution to be sprayed, additives, the concentration of the aqueous solution, heating temperature, and components and concentrations of atmospheres. Thus obtained ITO particles were refined to an impurity concentration of 0.1% or less.

Making of Transparent Conductive Films and Their Evaluation

An ethanol dispersion of ITO particles having an average particle size of at least 20 nm (hereinafter referred to as “ITO particles A”) was applied to a PET film (A), and the applied dispersion was dried. Then, another PET film (B) was mounted on the ITO particles A, and thus obtained product as a whole was pressed by a pressure roll, so as to form a sheet-shaped aggregate in which the ITO particles A were flocculated. After peeling off the PET film (B), thus formed aggregate was impregnated with a mixed liquid in which ITO particles having an average particle size of less than 20 nm (hereinafter referred to as “ITO particles B”), uncured acrylic resin, MEK (manufactured by Kanto Chemical Co., Inc.), and vinyltrimethoxysilane (manufactured by Shin-Etsu Chemical Co., Ltd.) were mixed. Used as the uncured acrylic resin was one constituted by an acrylic polymer (Shin-Nakamura Chemical Co., Ltd.), an acrylic monomer (Shin-Nakamura Chemical Co., Ltd.), and a photopolymerization initiator. After drying the infiltrated mixed liquid, the acrylic resin was cured with UV irradiation, so as to yield a transparent conductive film containing the conductive particles whose surface was hydrophobized with a vinyl group. The contents of ITO particles A and B in the conductive layer of thus obtained transparent conductive film were 75% by volume and 10% by volume, respectively.

Table 1 shows combinations of ITO particles A and B in thus produced transparent conductive films. The thin-film coil No. 9 was made without using the ITO particles B. In No. 8, a transparent conductive film containing unhydrophobized conductive particles was made without using vinyltrimethoxysilane. Each average particle size shown in Table 1 is an average value determined by the Scherrer equation from the half width of an x-ray diffraction peak obtained by an x-ray diffraction analysis of ITO particles. In the case of ITO particles, the average particle size determined according to the x-ray diffraction analysis substantially coincides with the average particle size determined by observing cross sections of the ITO particles.

The surface resistance of each of thus obtained transparent conductive films was measured by a 4-terminal, 4-probe surface resistivity meter. Further, the transparent conductive film was left for 1000 hr in an environment of 60° C., 95% RH, and the surface resistance was measured thereafter, whereby the change in resistance value between before and after the humidification was seen.

TABLE 1

| | Average particle size | | | Surface resistance (Ω/□) | | |
|---|---|---|---|---|---|---|
| | ITO | ITO | | | After | Ratio of |
| No. | Particles A | Particles B | B/A | Initial | humidification | change |
| 1 | 20 nm | 8 nm | 0.40 | 1727 | 3173 | x1.95 |
| 2 | 26 nm | 8 nm | 0.31 | 1255 | 2410 | x1.92 |
| 3 | 30 nm | 8 nm | 0.27 | 1056 | 1943 | x1.84 |
| 4 | 42 nm | 8 nm | 0.19 | 942 | 1696 | x1.80 |
| 5 | 60 nm | 4 nm | 0.06 | 752 | 1399 | x1.86 |
| 6 | 80 nm | 4 nm | 0.05 | 639 | 1252 | x1.96 |
| 7 | 22 nm | 11 nm | 0.50 | 1348 | 2534 | x1.88 |
| 8 | 30 nm | 8 nm | 0.27 | 880 | 1716 | x1.95 |
| 9 | 26 nm | — | — | 1525 | 3508 | x2.30 |
| 10 | 18 nm | 11 nm | 0.61 | 1686 | 3794 | x2.25 |
| 11 | 26 nm | 20 nm | 0.77 | 970 | 2280 | x2.35 |
| 12 | 90 nm | 4 | 0.04 | 470 | 1034 | x2.20 |

As shown in Table 1, the ratio of change in resistance between before and after the humidification was remarkably suppressed in the transparent conductive film Nos. 1 to 8 in which the ratio (B/A) of the average particle size of the ITO particles B to the average particle size of the ITO particles A fell within the range of 0.05 to 0.5, as compared with the transparent conductive film No. 9 using no ITO particles B and the transparent conductive film Nos. 10 to 12 whose B/A did not fall within the range of 0.05 to 0.5.

The foregoing results have verified that the present invention provides a highly reliable transparent conductive film whose change in resistance due to humidity is suppressed.

The present invention provides a transparent conductive film having a high reliability with a sufficiently suppressed change in resistance. The present invention is also excellent in that it can easily attain a lower resistance value as compared with conventional coating type transparent conductive films.

What is claimed is:

1. A transparent conductive film comprising a transparent conductive layer containing:
conductive particles constituted by first conductive particles having a particle size of at least 20 nm and second conductive particles having a particle size of less than 20 nm; and
a binder resin;
wherein R²/R¹ is 0.05 to 0.5, where R¹ is an average particle size of the first conductive particles, and R² is an average particle size of the second conductive particles.

2. A transparent conductive film according to claim 1, wherein the second conductive particles have a hydrophobized surface.

3. A transparent conductive film according to claim 1, wherein the second conductive particles have a hydrophilized surface.

4. A transparent conductive film according to claim 1, wherein a functional group which reacts with the binder resin is bonded to a surface of the second conductive particles.

5. A transparent conductive film according to claim 1, wherein the second conductive particles are unevenly distributed toward one surface side of the transparent conductive film in a thickness direction thereof.

6. A transparent conductive film according to claim 1, wherein the transparent conductive layer includes:
a conductive layer where the first and second conductive particles coexist as the conductive particles; and
a layer, formed on one side or both sides of the conductive layer, having only the second conductive particles distributed therein as the conductive particles.

7. A method of manufacturing a transparent conductive film, the method comprising the steps of:
forming a sheet-shaped aggregate including conductive particles having an average particle size of at least 20 nm flocculated therein; and
impregnating the aggregate with conductive particles having an average particle size of less than 20 nm together with a binder resin.
